(19) United States
(12) Patent Application Publication
(10) Pub. No.: US 2022/0396293 A1
(43) Pub. Date: Dec. 15, 2022

(54) AUTONOMOUS VEHICLE CARGO RESERVATION

(71) Applicant: GM Cruise Holdings LLC, San Francisco, CA (US)

(72) Inventors: Curt Harrington, San Francisco, CA (US); Wei Lu, San Bruno, CA (US); Devina Jain, San Francisco, CA (US); Kunal Mehta, San Francisco, CA (US); Nikola John Linn Noxon, San Francisco, CA (US)

(21) Appl. No.: 17/346,555

(22) Filed: Jun. 14, 2021

(51) Int. Cl. B60W 60/00; G05D 1/02; G07C 5/00; B60W 10/04; B60W 10/18; B60W 10/20; G06Q 10/02; G06Q 50/30; G06Q 10/06; G06T 7/62; G08B 5/22; G08B 21/18; G01G 19/08

(52) U.S. Cl. CPC B60W 60/00253; G05D 1/0276; G07C 5/008; B60W 10/04; B60W 10/18; B60W 10/20; G05D 1/0291; G06Q 10/02; G06Q 50/30; G06Q 10/06315; G06T 7/62; G08B 5/22; G08B 21/182; G01G 19/08; B60W 2420/42; B60R 25/20

(57) ABSTRACT

Described herein are various technologies pertaining to selecting an autonomous vehicle for a trip of a passenger based on a passenger cargo reservation request and real time load data from a fleet of autonomous vehicles. The passenger cargo reservation request specifies a request to store passenger cargo in a cargo storage area of an autonomous vehicle during a ride of a passenger in the autonomous vehicle. Further, an autonomous vehicle from the fleet of autonomous vehicles can be selected for the trip of the passenger based on the passenger cargo reservation request and the real time load data for the autonomous vehicles in the fleet of autonomous vehicles.

### BACKGROUND

An autonomous vehicle is a motorized vehicle that can operate without a human driver. A user can submit a ride request for a trip in an autonomous vehicle to a computing system, where the computing system selects an autonomous vehicle for the trip. The autonomous vehicle can be selected by the computing system for the trip based on proximity of the autonomous vehicle to the user, current occupancy of the autonomous vehicle, scheduled occupancy of the autonomous vehicle, and locations to which the autonomous vehicle is scheduled to travel, for instance. However, if the user is attempting to travel with cargo (e.g., groceries, suitcases, etc.) during the trip, space in a trunk of the autonomous vehicle selected for the trip of the user may be unavailable, resulting in the user either declining to ride in the selected autonomous vehicle (and requesting another autonomous vehicle) or trying to sit with the cargo in his or her lap in the passenger cabin.

### SUMMARY

The following is a brief summary of subject matter that is described in greater detail herein. This summary is not intended to be limiting as to scope of the claims.

Described herein are various technologies pertaining to selecting an autonomous vehicle based on a passenger cargo reservation for a trip of the passenger in the autonomous vehicle. With more specificity, a user can submit a passenger cargo reservation request to a dispatch server system. The passenger cargo reservation request can specify a size, shape, and/or number of items included in the passenger cargo, for example. According to another example, the passenger cargo reservation request can indicate an amount of a cargo storage area of an autonomous vehicle desirably reserved for the user (e.g., the passenger cargo reservation request can specify that the user desirably reserve 25%, 50%, 75%, or 100% of the cargo storage area of an autonomous vehicle in which the user is to ride). The passenger cargo reservation request can be included as part of a ride request submitted by the user to the dispatch server system, where the ride request indicates that the user requests a trip in an autonomous vehicle (e.g., specifying a pick-up location, a drop-off location, a pick-up time, a desired arrival time, etc. for the trip). Responsive to receiving the passenger cargo reservation request (and the ride request), the dispatch server system can identify an amount of space in a cargo storage area (e.g., a trunk) of an autonomous vehicle to accommodate the passenger cargo during the trip based on the passenger cargo reservation request. The dispatch server system can be further configured to collect real time load data from autonomous vehicles in a fleet of autonomous vehicles. The real time load data can indicate utilized space in respective cargo storage areas of autonomous vehicles in the fleet of autonomous vehicles. The utilized space of an autonomous vehicle can include space in the cargo storage area of the autonomous vehicle that is currently occupied by passenger cargo of other passenger(s) as well as space in the cargo storage area that is reserved for other passenger(s) to be picked up. Moreover, the real time load data can specify time period(s) during which the space in the cargo storage area is to be utilized (e.g., based on time period(s) during which the other passenger(s) are scheduled to ride in the autonomous vehicle). When scheduling an autonomous vehicle to provide the ride for the user responsive to the ride request, the dispatch server system can select the autonomous vehicle from the fleet of autonomous vehicles based at least in part on the autonomous vehicle being able to accommodate the passenger cargo reservation request to store the passenger cargo during the trip.

According to various embodiments, the dispatch server system can identify potential autonomous vehicles from the fleet that can potentially provide the requested ride for the user (responsive to receiving the ride request from the user). The dispatch server system can transmit information specifying the potential autonomous vehicles and respective availability of space within cargo storage areas of the potential autonomous vehicles to a computing device of the user (as well as estimated pick-up and/or drop-off times). The computing device of the user can present the information specifying the potential autonomous vehicles and the corresponding availability of space within the cargo storage areas. For instance, for each of the potential autonomous vehicles, the computing device can indicate an amount of available space within the cargo storage area as well as an estimated pick-up time and/or estimated drop-off time for the requested ride in the potential autonomous vehicle if the user rides in the potential autonomous vehicle. Accordingly, a particular autonomous vehicle from the potential autonomous vehicles can be selected by the user (e.g., responsive to user input received by the computing device of the user).

In various embodiments, the dispatch server system may be configured to reserve the cargo storage area (or a portion thereof) for the user. For instance, the dispatch server system can be configured to cause the autonomous vehicle to prevent other users from accessing the cargo storage area (e.g., causing the autonomous vehicle to lock the cargo storage area for other passenger(s) for whom a portion of the cargo storage area is not reserved). According to another illustration, the dispatch server system can be configured to allot a certain amount of space in a cargo storage area of an autonomous vehicle for the user and the autonomous vehicle can be configured to inform the user if the passenger cargo placed in the cargo storage area of the autonomous vehicle by the user exceeds the allotted space.

The above-described technologies present various advantages over conventional ride request approaches. Unlike the conventional approach of requesting a ride in an autonomous vehicle and assuming there will be adequate space to store passenger cargo, the herein-described technologies allow a user to request an autonomous vehicle with adequate space to store the passenger cargo and reserve such space within the cargo storage area of the autonomous vehicle. Moreover, the herein-described technologies permit a user to reserve specific space in the cargo storage area to prevent the space from being filled prior to the autonomous vehicle reaching the pick-up location for the trip of the passenger.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates an exemplary system configured to reserve a cargo storage area (or a portion thereof) of an autonomous vehicle from a fleet of autonomous vehicles for storing passenger cargo during a trip of a passenger in the autonomous vehicle.

FIG. 2 illustrates an exemplary dispatch server system in communication with an exemplary autonomous vehicle.

FIG. 3 illustrates an exemplary mobile computing device.

FIG. 4 illustrates an exemplary driving environment of a plurality of autonomous vehicles.

FIG. 5 is a flow diagram that illustrates an exemplary methodology executed by a dispatch server system for identifying an autonomous vehicle from a fleet of autonomous vehicles to store passenger cargo during a trip of a passenger.

FIG. 6 is a flow diagram that illustrates an exemplary methodology executed by an autonomous vehicle for a trip of a user.

FIG. 7 is a flow diagram that illustrates an exemplary methodology executed by a mobile computing device for submitting a request to store passenger cargo during a trip of the passenger in an autonomous vehicle.

FIG. 8 illustrates an exemplary computing device.

### DETAILED DESCRIPTION

Various technologies pertaining to selecting an autonomous vehicle for a trip of a passenger based on the passenger requesting to store passenger cargo in the autonomous vehicle during the trip are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something and is not intended to indicate a preference.

Disclosed are various technologies that generally relate to reserving passenger cargo space (e.g., space in a trunk) for a trip in an autonomous vehicle. A dispatch server system receives a ride request from a user (e.g., from a device of the user). The ride request can indicate that the user requests a trip in an autonomous vehicle (e.g., specifying a pick-up location, a drop-off location, a pick-up time, a desired arrival time, etc. for the trip). The ride request can further include a passenger cargo reservation request indicating a request to store passenger cargo during the trip in the autonomous vehicle. The passenger cargo reservation request can be included as part of the ride request and/or can be a separate request. The dispatch server system can select an autonomous vehicle with space to store the passenger cargo based at least in part on the passenger cargo reservation request. The passenger cargo reservation request can indicate a size, shape, and/or number of items included in the passenger cargo of the user. Such information can be used to determine how much space is needed to store the passenger cargo. According to another example, the passenger cargo reservation request can indicate an amount of a cargo storage area of an autonomous vehicle desirably reserved for the user (e.g., the passenger cargo reservation request can specify that the user desirably reserve 25%, 50%, 75%, or 100% of the cargo storage area of an autonomous vehicle in which the user is to ride). The autonomous vehicle can be selected from the autonomous vehicle(s) determined to be able to accommodate the passenger cargo.

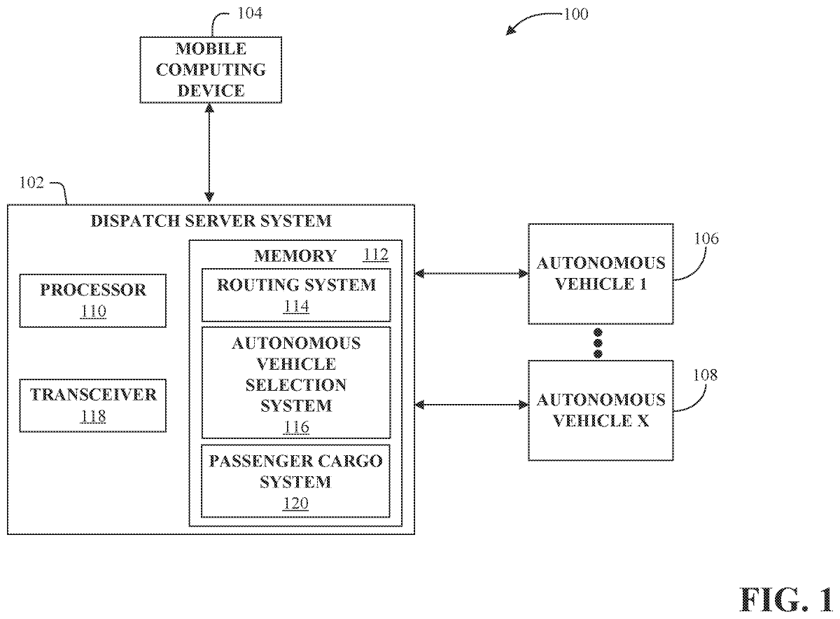

With reference now to FIG. 1, illustrated is a system 100 configured to reserve a cargo storage area (or a portion thereof) of an autonomous vehicle from a fleet of autonomous vehicles for storing passenger cargo during a trip of a passenger in the autonomous vehicle. The system 100 can be configured to select an autonomous vehicle from a fleet of autonomous vehicles, where the autonomous vehicle that is selected has sufficient space to store the passenger cargo. More specifically, in the system 100, a user can transmit a ride request requesting a trip in an autonomous vehicle and a passenger cargo reservation request requesting space to store passenger cargo during the trip in the autonomous vehicle to a dispatch server system 102. The ride request and the passenger cargo reservation request can be sent as part of a same request or separate requests. The dispatch server system 102 can further receive real time load data from a fleet of autonomous vehicles that indicates available storage capacity in the autonomous vehicles of the fleet. The dispatch server system 102 selects the autonomous vehicle from the fleet of autonomous vehicles for the trip of the passenger at least in part based on the real time load data and the passenger cargo reservation request.

As illustrated in FIG. 1, the system 100 can include the dispatch server system 102, which is in communication with a mobile computing device 104 of a user. While described herein as being a mobile computing device, it is contemplated that substantially any type of user device can be utilized by the user. Moreover, it is to be appreciated that substantially any number of user devices can be in communication with the dispatch server system 102. The mobile computing device 104, for instance, can be a smartphone, a tablet computing device, a wearable computing device, etc. By way of another example, the device can comprise a personal computer.

In the illustrated embodiment, the dispatch server system 102 is in communication with a plurality of autonomous vehicles, namely, autonomous vehicle 1 106, . . . , and autonomous vehicle X 108 (collectively referred to herein as autonomous vehicles 106-108), where X can be substantially any integer greater than 1. The autonomous vehicles 106-108 may be in the same fleet of autonomous vehicles and/or may be part of different fleets of autonomous vehicles. In another embodiment, the dispatch server system 102 can be in communication with a single autonomous vehicle.

In order to transmit data to the device 104 and/or the autonomous vehicles 106-108 and/or receive data therefrom, the dispatch server system 102 may include a transceiver 118. The transceiver 118 is configured to transmit data from the dispatch server system 102 and/or receive data at the dispatch server system 102. Thus, the dispatch server system 102 can be in communication with the mobile computing device 104 and/or the autonomous vehicles 106-108 via the transceiver 118.

The dispatch server system 102 is configured to receive a ride request for a trip of a passenger from the mobile computing device 104 and, in response to receiving the ride request, to select an autonomous vehicle from the autonomous vehicles 106-108 for trip of the passenger. The ride request can specify a pick-up location, a drop-off location, a pick-up time, a desired arrival time, etc. for the trip. The ride request can further include a passenger cargo reservation request requesting space in a cargo storage area of the autonomous vehicle to store passenger cargo during the trip of the passenger. The passenger cargo reservation request can be part of the ride request and/or can be a separate request sent from the mobile computing device 104 to the dispatch server system 102. The dispatch server system 102 can select the autonomous vehicle based at least in part on the passenger cargo reservation request (as well as available room to store the passenger cargo during the trip).

The dispatch server system 102 can collect real time load data from one or more of the autonomous vehicles 106-108. The real time load data can indicate utilized space in respective cargo storage areas (e.g., trunks) of the autonomous vehicles 106-108. The utilized space of an autonomous vehicle can include space in the cargo storage area of the autonomous vehicle that is currently occupied by passenger cargo of other passenger(s) as well as space in the cargo storage area that is reserved for other passenger(s) to be picked up. Moreover, the real time load data can specify time period(s) during which the space in the cargo storage area is to be utilized (e.g., based on time period(s) during which the other passenger(s) are scheduled to ride in the autonomous vehicle). The dispatch server system 102 can compare the requested space specified in the passenger cargo reservation request to available space in the cargo storage areas of the autonomous vehicles 106-108 (indicated by the real time load data) to determine which autonomous vehicle(s) (if any) from the autonomous vehicles 106-108 have room to store the passenger cargo. Accordingly, the dispatch server system 102 can select an autonomous vehicle from the autonomous vehicles 106-108 based at least in part on the foregoing. Further, the dispatch server system 102 can select the autonomous vehicle from the autonomous vehicles 106-108 based on proximity of the autonomous vehicles 106-108 to the user, current occupancies of the autonomous vehicles 106-108, scheduled occupancies of the autonomous vehicles 106-108, locations to which the autonomous vehicles 106-108 are scheduled to travel, a combination thereof, and so forth.

According to various embodiments, the dispatch server system 102 can select the autonomous vehicle for the trip of the passenger. Pursuant to other embodiments, the dispatch server system 102 can identify potential autonomous vehicles from the autonomous vehicles 106-108 that can potentially provide the requested ride for the user (e.g., a subset of autonomous vehicle from the autonomous vehicles 106-108 that can accommodate the passenger cargo reservation request); accordingly, the autonomous vehicle can be selected from the potential autonomous vehicles based on user input (e.g., a selection) made by the user of the mobile computing device 104 to select the autonomous vehicle for the trip. For example, the dispatch server system 102 can transmit information about one or more of the autonomous vehicles 106-108 to the mobile computing device 104. The information can include location, available room, estimated travel time to the pick-up location (e.g., estimated pick-up time), estimated time of drop off at a drop-off location, and/or the like. The mobile computing device 104 can present such information to the user, and the user can select an autonomous vehicle for the trip of the passenger based upon the presented information.

The foregoing can allow a user to select an autonomous vehicle that has available storage space that is smaller than a requested amount of cargo storage area but is desirable for another reason. For instance, the user can select an autonomous vehicle that is closer to the pick-up location but with available storage space that is smaller than the passenger cargo. Accordingly, the user can elect to store a portion of the passenger cargo in the storage space and travel with the remaining portion of the passenger cargo in their lap. Thus, a user is not limited to only autonomous vehicles that meet the minimum storage space necessary to hold the passenger cargo.

The dispatch server system 102 can include a processor 110 and memory 112, where the memory 112 includes computer-executable instructions that are executed by the processor 110. In an example, the processor 110 can be or include a graphics processing unit (GPU), a plurality of GPUs, a central processing unit (CPU), a plurality of CPUs, an application-specific integrated circuit (ASIC), a microcontroller, a programmable logic controller (PLC), a field programmable gate array (FGPA), a combination thereof, or the like. The memory 112 may include a routing system 114, an autonomous vehicle selection system 116, and/or a passenger cargo system 120, which are described in detail below.

The routing system 114 is configured to identify at least one route from an initial location (e.g., pick-up location) to a destination (e.g., drop-off location) of the trip of the passenger. The dispatch server system 102 may identify the at least one route by accessing roadway information (e.g., maintained by the dispatch server system 102). The initial location and/or the destination can be set based on the ride request received from the mobile computing device 104, where the ride request can specify the pick-up location and the drop-off location.

The autonomous vehicle selection system 116 is configured to select an autonomous vehicle from the autonomous vehicles 106-108 for the trip of the passenger based on the ride request from the mobile computing device 104. The autonomous vehicle selection system 116 can further be configured to select the autonomous vehicle from the autonomous vehicles 106-108 for the trip of the passenger based on the passenger cargo reservation request. In order to identify which autonomous vehicle from the autonomous vehicles 106-108 is suitable, the dispatch server system 102 is configured to collect real time load data from the autonomous vehicles 106-108. The autonomous vehicles 106-108 can transmit their respective real time load data to the dispatch server system 102.

The real time load data can comprise any suitable information to inform the autonomous vehicle selection system 116 about available storage space in an autonomous vehicle (e.g., autonomous vehicle 1 106). The passenger cargo can be stored in any suitable storage location within the autonomous vehicle. For instance, in one embodiment, the passenger cargo is stored in a cargo storage area (e.g., a trunk) of the autonomous vehicle. In another embodiment, the passenger cargo is stored multiple parts of the autonomous vehicle, such as the cargo storage area and a passenger compartment. In the following embodiments, real time load data is discussed with reference to storing the passenger cargo in the cargo storage area, however similar methods can be used for other storage locations.

In one embodiment, the real time load data can comprise information indicating that a portion of the cargo storage area is occupied, such as with other passenger's cargo. The autonomous vehicle selection system 116 can determine available space in the cargo storage area based on the real time load data. In another embodiment, the autonomous vehicle can determine the available portion in the cargo storage area and the real time load data can comprise information indicating this available portion.

The autonomous vehicle selection system 116 can filter out autonomous vehicle(s) from the autonomous vehicles 106-108 that do not meet a minimum available space specified by the passenger cargo reservation request. For instance, where the passenger cargo would occupy 80% of the cargo storage area, the autonomous vehicle selection system 116 can filter out autonomous vehicles with less than 80% available space. In another example, the autonomous vehicle selection system 116 can set a minimum available space requirement that is higher than the amount of space that would be occupied by the passenger cargo.

The autonomous vehicle selection system 116 can be further configured to filter the autonomous vehicles based on the type and/or size of the passenger cargo. For instance, where the passenger cargo comprises a bicycle, the autonomous vehicle selection system 116 can filter out vehicles that do not include a bicycle rack. In another example, where the passenger cargo comprises a long object (e.g., a cello), the autonomous vehicle selection system 116 can filter out vehicles that have a cargo storage area below a threshold square area and/or a non-expandable cargo storage area (e.g., a seat can't be put down to expand the cargo storage area).

The autonomous vehicle selection system 116 can identify an appropriate autonomous vehicle from the filtered autonomous vehicles. For instance, the autonomous vehicle selection system 116 can identify which autonomous vehicle is nearest a pick-up location and has a seat available for trip of the passenger. Subsequent to identifying the appropriate autonomous vehicle, the autonomous vehicle selection system 116 can transmit information specifying the route from the routing system 114 to that autonomous vehicle.

The passenger cargo system 120 is configured to use information included in the passenger cargo reservation request to determine the amount of space that would be occupied by the passenger cargo. For instance, the information can include a number and/or type of passenger cargo, such as three bags of groceries. In another example, the information can include an image of the passenger cargo, such as a picture of the passenger cargo captured with a camera of the mobile computing device. However, in other embodiments, the passenger cargo reservation request can indicate an amount of a cargo storage area of an autonomous vehicle desirably reserved for the user. For instance, the passenger cargo reservation request can specify that the user desirably reserve 25%, 50%, 75%, or 100% of the cargo storage area of an autonomous vehicle in which the user is to ride; however, substantially any other percentages of the cargo storage area can be specified in the passenger cargo reservation request.

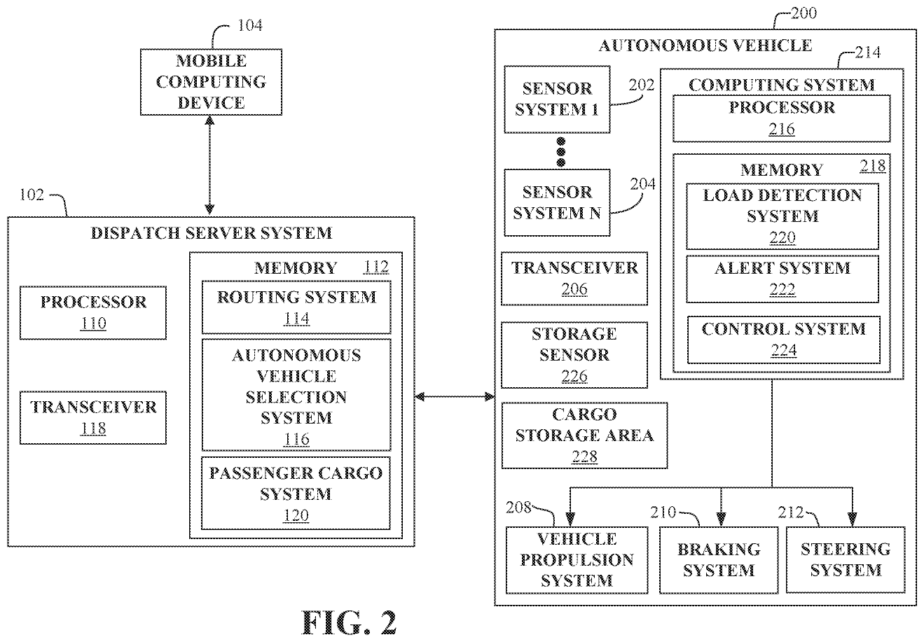

Turning now to FIG. 2, illustrated is an exemplary autonomous vehicle 200 (e.g., one of the autonomous vehicles 106-108) that is in communication with the dispatch server system 102. The autonomous vehicle 200 can navigate about roadways without human conduction based upon sensor signals output by sensor systems of the autonomous vehicle 200. The autonomous vehicle 200 includes a plurality of sensor systems, namely, a sensor system 1 202, . . . , and a sensor system N 204 (collectively referred to herein as sensor systems 202-204), where N can be substantially any integer greater than 1. The sensor systems 202-204 are of different types and may be arranged about the autonomous vehicle 200. For example, the sensor system 1 202 may be a lidar sensor system and the sensor system N 204 may be a camera (image) system. Other exemplary sensor systems 202-204 included are radar sensor systems, global positioning system (GPS) sensor systems, sonar sensor systems, infrared sensor systems, hybrid sensor systems (e.g., combining two or more sensor modalities), and the like.

The autonomous vehicle 200 further includes several mechanical systems that are used to effectuate appropriate motion of the autonomous vehicle 200. For instance, the mechanical systems can include, but are not limited to, a vehicle propulsion system 208, a braking system 210, and a steering system 212. The vehicle propulsion system 208 may be an electric motor, an internal combustion engine, a combination thereof, or the like. The braking system 210 can include an engine brake, brake pads, actuators, and/or any other suitable componentry that is configured to assist in decelerating the autonomous vehicle 200. The steering system 212 includes suitable componentry that is configured to control the direction of the movement of the autonomous vehicle 200.

The autonomous vehicle 200 further includes a cargo storage area 228. The cargo storage area 228 can be a trunk of the autonomous vehicle. According to another illustration, the cargo storage area 228 can include a plurality of storage compartments in the autonomous vehicle (e.g., each of which can be individually lockable and unlockable by the autonomous vehicle 200). Yet, other types of cargo storage areas are intended to fall within the scope of the hereto appended claims.

Similar to the computing system 102, in order to transmit data and/or receive data, the autonomous vehicle 200 may further include a transceiver 206. The transceiver 206 is configured to transmit data from the autonomous vehicle 200 and/or receive data at the autonomous vehicle 200. Thus, the autonomous vehicle 200 can be in communication with the dispatch server system 102.

The autonomous vehicle 200 additionally comprises a computing system 214 that is in communication with the sensor systems 202-204, the transceiver 206, the vehicle propulsion system 208, the braking system 210, and/or the steering system 212. The computing system 214 includes a processor 216 and memory 218; the memory 218 includes computer-executable instructions that are executed by the processor 216. In an example, the processor 216 can be or include a GPU, a plurality of GPUs, a CPU, a plurality of CPUs, an ASIC, a PLC, an FPGA, a microcontroller, a combination thereof, or the like.

The memory 218 includes a control system 224 configured to control operation of the vehicle propulsion system 208, the braking system 210, and/or the steering system 212. The memory 218 may further include a load detection system 220 configured to monitor the cargo storage area 228 to provide the load data to the dispatch server system 102. The memory 218 may yet further include an alert system 222 configured to present one or more messages to a passenger(s) of the autonomous vehicle 200.

The load detection system 220 is configured to receive data from a storage sensor 226 in the autonomous vehicle 200 and to transmit real time load data to the dispatch server system 102 based on the storage sensor data. The storage sensor 226 is configured to output data indicative of a condition of the cargo storage area 228 in the autonomous vehicle 200. For instance, the storage sensor 226 can output data indicating space (if any) in the cargo storage area 228 occupied by other cargo, weight of cargo currently occupying the cargo storage area 228, and so forth.

In one embodiment, the storage sensor 226 comprises a weight scale configured to determine a weight of passenger cargo in the cargo storage area 228. In another embodiment, the storage sensor 226 comprises a camera that captures an image of the cargo storage area 228. The load detection system 220 can use the image to determine the occupied space in the cargo storage area 228 and/or the image can be transmitted by the load detection system 220 to dispatch server system 102 to determine the occupied space in the cargo storage area 228. For instance, the load detection system 220 can compare the captured image to a stored image of an unoccupied cargo storage area 228 to determine the occupied space in the cargo storage area 228.

The load detection system 220 can collect the information from the storage sensor 226 at any suitable rate. For instance, the information can be collected continuously (e.g., a continuous video of the cargo storage area 228 captured by the camera). In another example, the information can be collected at predefined intervals (e.g., every 30 minutes), every time the cargo storage area 228 is accessed, and/or when the autonomous vehicle selection system 116 is attempting to identify one or more suitable autonomous vehicles in the autonomous vehicles 106-108 for the trip of the passenger.

In an embodiment, the computing system 214 can be further configured to store information relating to the type of cargo already stored within the autonomous vehicle 200. For instance, when a passenger stores and/or removes passenger cargo from the cargo storage area 228, the computing system 214 can update a stored cargo inventory. The information in the stored cargo inventory (e.g., the type of passenger cargo) can be based on the ride request received by the dispatch server system 102 and/or detected by the storage sensor 226. The load data transmitted to the dispatch server system 102 can include this stored cargo inventory for use by the autonomous vehicle selection system 116 in identifying an autonomous vehicle for the trip of the passenger. For instance, where the stored cargo inventory for the autonomous vehicle 200 includes large or bulky cargo (e.g., suitcases), the autonomous vehicle selection system 116 may filter out the autonomous vehicle 200 when the passenger cargo comprises a fragile object (e.g., eggs) to prevent the bulky cargo from breaking the fragile object.

As mentioned above, the alert system 222 can be configured to present a message(s) to the passenger. The message can be presented by way of a speaker in the autonomous vehicle 200 and/or a display in the autonomous vehicle 200. Additionally or alternatively, the message can be transmitted to the mobile computing device 104 for presentation thereby. Different messages can be presented for different situations. For instance, a message can be presented reminding the passenger to check the cargo storage area 228 when the autonomous vehicle 200 reaches a destination for the trip, regardless of whether the passenger stored passenger cargo for the trip.

In another example, a message can be presented when passenger cargo stored in the cargo storage area 228 exceeds an allotted amount of the cargo storage area 228. For instance, the dispatch server system 102 and/or the computing system 214 can allot a specific amount of the cargo storage area 228 for the passenger based on the passenger cargo reservation request. If the passenger attempts to store passenger cargo that exceeds the allotted amount of space, the alert system 222 can present a message informing the passenger that they have exceeded their allotted amount.

In addition to controlling operation of the vehicle propulsion system 208, the braking system 210, and/or the steering system 212, the control system 224 may be further configured to control access to the cargo storage area 228. For instance, the control system 224 may prevent access to the cargo storage area 228 (e.g., by locking the trunk) for a passenger(s) who did not request room to store passenger cargo.

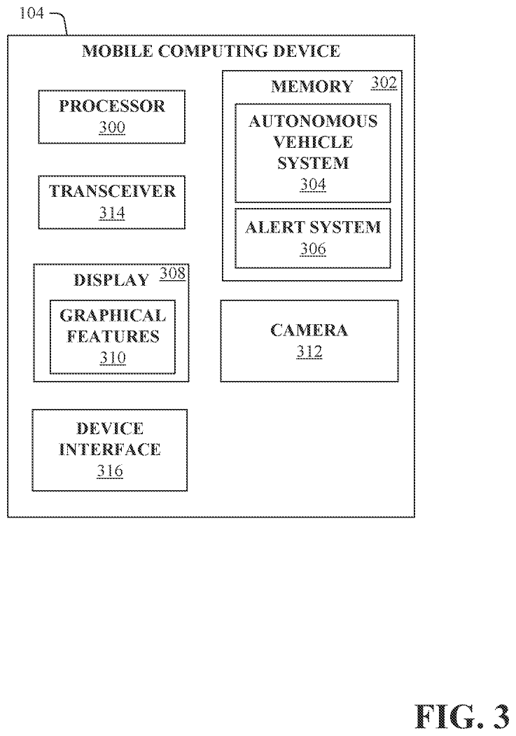

Turning now to FIG. 3, illustrated is an exemplary mobile computing device 104. The mobile computing device 104 can include a device interface 316 configured to receive an input from a user of the mobile computing device 104. According to another example, input from the user of the mobile computing device 104 can be received via a display 308 (e.g., a touchscreen); for instance, the display 308 can be or include the device interface 316. The mobile computing device 104 further includes a processor 300 and memory 302, where the memory 302 includes computer-executable instructions that are executed by the processor 300. In an example, the processor 300 can be or include a GPU, a plurality of GPUs, a CPU, a plurality of CPUs, an ASIC, a microcontroller, an FPGA, a combination thereof, or the like.

The memory 302 includes an autonomous vehicle system 304 that interfaces with the dispatch server system 102 and/or the autonomous vehicle 200. The autonomous vehicle system 304 can be configured to receive input from a user and generate a ride request for a ride in an autonomous vehicle based on the input. The autonomous vehicle system 304 can further be configured to transmit the ride request, via a transceiver 314, to the dispatch server system 102. The ride request can include a pick-up location and/or a destination for the trip of the passenger. The ride request can further include a passenger cargo reservation request requesting to store passenger cargo in the autonomous vehicle during the trip of the passenger. While described as being part of the ride request, it is contemplated that the passenger cargo reservation request can be transmitted separately from the ride request from the mobile computing device 104 to the dispatch server system 102.

The passenger cargo reservation request can include an indication of the size of the passenger cargo that is then used by the dispatch server system 102 to calculate an amount of cargo storage area that would be used up by the passenger cargo. For instance, the autonomous vehicle system 304 can present a plurality of options that are selectable by the user to indicate the size of the passenger cargo, such as “small,” “medium,” and/or “large.” The autonomous vehicle system 304 can provide the user with examples to assist the user with selecting an appropriate size, e.g., an example of “small” cargo comprises a grocery bag. In another example, the user can indicate a desire to reserve the whole cargo storage area, e.g., prevent any other passenger from storing passenger cargo in the cargo storage area. In yet another example, the user can indicate a percentage of the cargo storage area desirably reserved for the ride. By way of illustration, the user can specify a desire to reserve 25%, 50%, 75%, or 100% of the cargo storage area; however, it is contemplated that other percentages are intended to fall within the scope of the hereto appended claims. Additionally, the autonomous vehicle system 304 can allow the user to indicate a number of objects in the passenger cargo. For example, the user can indicate that the passenger cargo comprises 4 grocery bags.

In another example, an image of the passenger cargo can be captured with a camera 312 that is then used to determine a size of the passenger cargo. In one embodiment, the autonomous vehicle system 304 is configured to use the image to determine the size of the passenger cargo which is then transmitted to the dispatch server system 102. In another embodiment, the image is transmitted by the autonomous vehicle system 304 to the dispatch server system 102 which then uses the passenger cargo system 120 to determine the size of the passenger cargo system.

The autonomous vehicle system 304 can be further configured receive information indicative of one or more of the autonomous vehicles 106-108 from the dispatch server system 102 and to present this information to the user. The information can include location, available room, estimated travel time to the pick-up location, anticipated drop-off time, and/or the like. The user can select the autonomous vehicle for the trip from the presented autonomous vehicle(s). This selection is then transmitted to the dispatch server system 102.

This can allow a user to select an autonomous vehicle that has available storage space that is smaller than passenger cargo. For instance, the user can select an autonomous vehicle that is closer to the pick-up location but with available storage space that is smaller than the passenger cargo. Accordingly, the user can elect to store a portion of the passenger cargo in the storage space and travel with the remaining portion of the passenger cargo in their lap. Thus, a user is not limited to waiting for only autonomous vehicles that meet the minimum storage space necessary to hold the passenger cargo.

The mobile computing device 104 may include a display 308, whereupon graphical features 310 may be presented. For instance, a GUI for the autonomous vehicle application 304 may be presented as part of the graphical features 310. For instance, the information regarding the autonomous vehicle(s) from the dispatch server system 102 can be presented on the display 308.

The memory 302 further includes an alert system 306 configured to present the message(s) generated by the alert system 222 in the autonomous vehicle 200. In one embodiment, the message can be presented textually on the display 308. In another embodiment, the message is presented audibly by a speaker (not pictured) in the mobile computing device 104.

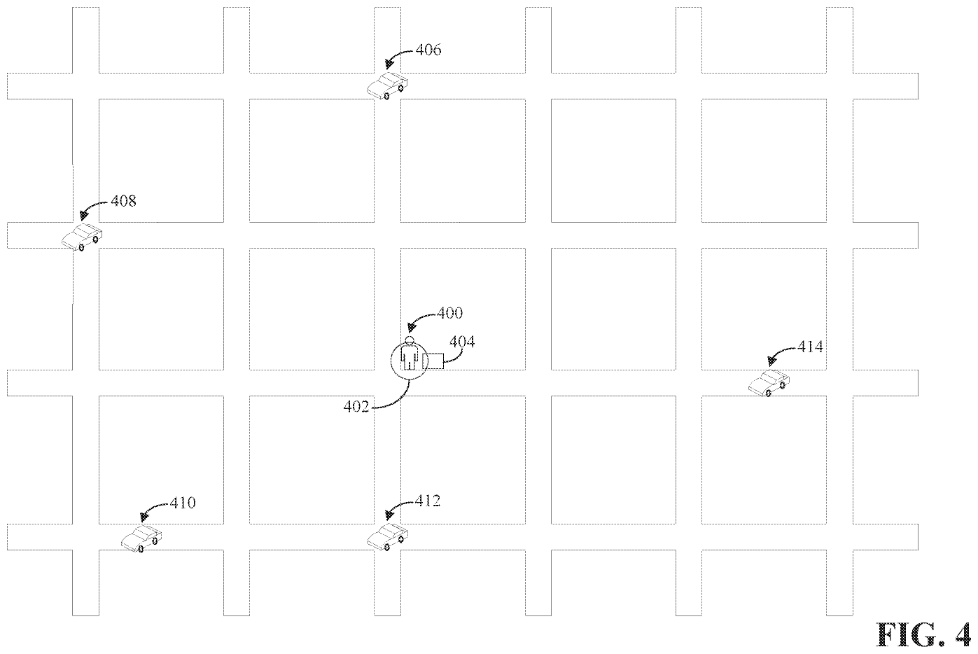

Turning now to FIG. 4, illustrated is an exemplary embodiment of selecting an autonomous vehicle to store passenger cargo during a trip of the passenger using the techniques described above. In the illustrated embodiment, a passenger 400 submits a ride request to the dispatch server system 102 for a trip in an autonomous vehicle from a pick-up location 402. The submitted ride request further indicates a desire to store passenger cargo 404 during the trip (e.g., via a passenger cargo reservation request). The passenger 400 can indicate the size, shape, and number of times included as part of the passenger cargo 404 in the passenger cargo reservation request. This size, shape, and/or number of items can be used by dispatch server system 102 to select a suitable autonomous vehicle(s) from a fleet of autonomous vehicles.

In the illustrated embodiment, dispatch server system 102 is in communication with a fleet of autonomous vehicles, namely, a first autonomous vehicle 406, a second autonomous vehicle 408, a third autonomous vehicle 410, a fourth autonomous vehicle 412, and a fifth autonomous vehicle 414 (collectively referred to herein as autonomous vehicles 406-414). The autonomous vehicles 406-414 can transmit real time load data to the dispatch server system 102 indicative of a condition of their respective cargo storage areas (e.g., available space and/or occupied space). For instance, the first autonomous vehicle 406 can indicate that 50% of its cargo storage area is available, the second autonomous vehicle 408 can indicate that 20% of its cargo storage area is available, the third autonomous vehicle 410 can indicate that 0% of its cargo storage area is available, the fourth autonomous vehicle 412 can indicate that 40% of its cargo storage area is available, and the fifth autonomous vehicle 414 can indicate that 80% of its cargo storage area is available. This real time load data can be used to select the suitable autonomous vehicle for the trip of passenger.

In one example, the dispatch server system 102 uses this real time load data to filter the autonomous vehicles 406-414. More particularly, the passenger cargo reservation request can indicate that the passenger cargo 404 requests at least 50% of a cargo storage area to be available to hold the passenger cargo 404. Accordingly, the dispatch server system 102 can filter out the second autonomous vehicle 408, the third autonomous vehicle 410, and the fourth autonomous vehicle 412 because each have less than 50% available area in their cargo storage area. After filtering out autonomous vehicles with insufficient room in the cargo storage area, the dispatch server system 102 can select from the remaining autonomous vehicle(s) based on other factors. For instance, dispatch server system 102 can select the autonomous vehicle based on distance from the pick-up location 402, amongst other factors. In the illustrated case, this results in the dispatch server system 102 selecting the first autonomous vehicle 406 for the trip of the passenger 400.

In another example, the dispatch server system 102 transmits data about the autonomous vehicles 406-414 to the mobile computing device 104 of the passenger 400 and the passenger 400 selects the autonomous vehicle for the trip. In one embodiment, the dispatch server system 102 can filter out the autonomous vehicles that have less available cargo storage area than requested in the passenger cargo reservation request. The passenger 400 can then select from the filtered autonomous vehicles (e.g., the first autonomous vehicle 406 and the fifth autonomous vehicle 414). The passenger 400 can be presented with information regarding estimated time to the pick-up location 402, the available cargo storage area, anticipated time of drop-off at a destination of the user, and/or any other suitable information for the autonomous vehicles. For instance, the passenger 400 may select the fifth autonomous vehicle 414 for the trip because it has more available cargo storage area as compared to the first autonomous vehicle 406 (80% vs. 50%), even though the travel time to the pick-up location 402 is longer for the fifth autonomous vehicle 414 than the first autonomous vehicle 406.

In another embodiment, the passenger 400 can select from the autonomous vehicles 406-414 in communication with the dispatch server system 102. Instead of filtering the autonomous vehicles 406-414, the dispatch server system 102 can transmit the information to the mobile computing device 104. The passenger 400 than selects from all the autonomous vehicles 406-414. The autonomous vehicle system 304 of the mobile computing device 104 can permit the passenger 400 to filter the autonomous vehicles 406-414 such as by distance from the pick-up location 402, available cargo storage area, type of autonomous vehicle, and/or the like. By allowing the passenger 400 to select from the available autonomous vehicles 406-414, the system 100 allows for the passenger 400 to split up the passenger cargo 404 to store a portion in the cargo storage area and to retain a portion with them in the passenger sitting area. For instance, even though the fourth autonomous vehicle 412 has available cargo storage area that is less than is needed to store the passenger cargo 404, the fourth autonomous vehicle 412 is the closest to the pick-up location 402. Accordingly, if the passenger 400 is willing to hold a portion of the passenger cargo 404 in their lap during the trip, the passenger 400 can select the fourth autonomous vehicle 412 to wait the least amount of time for an autonomous vehicle for the trip.

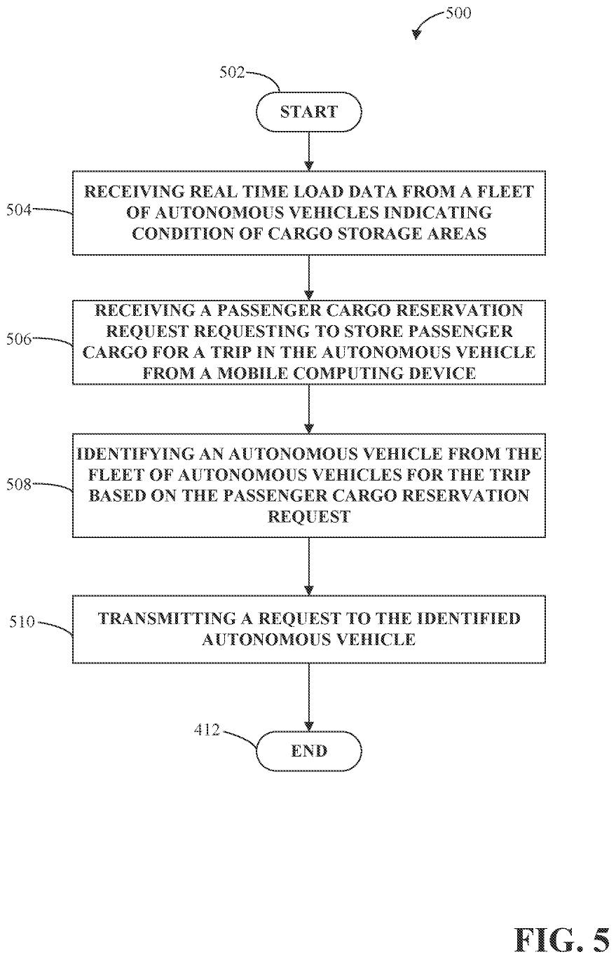

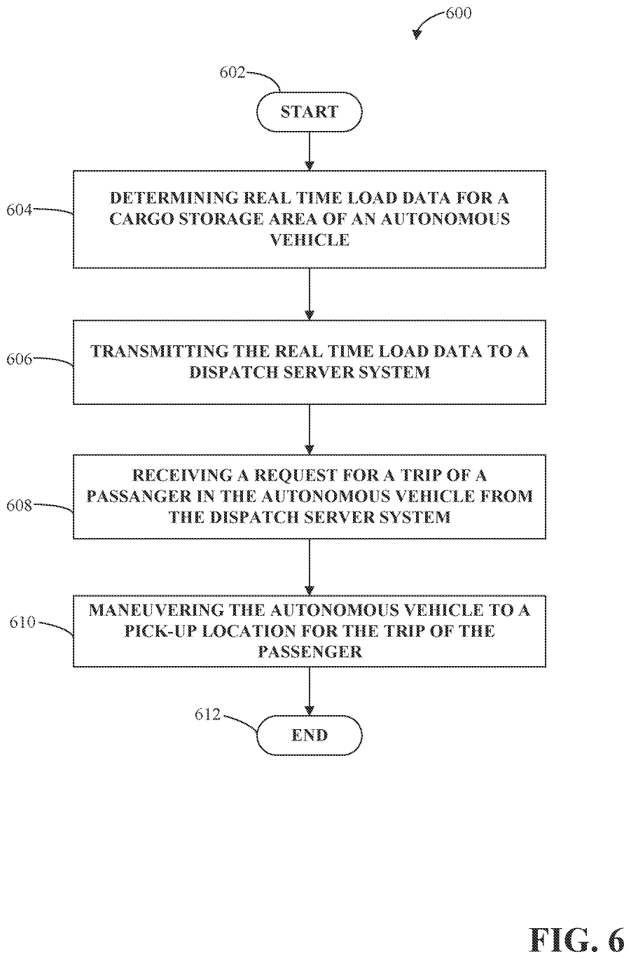

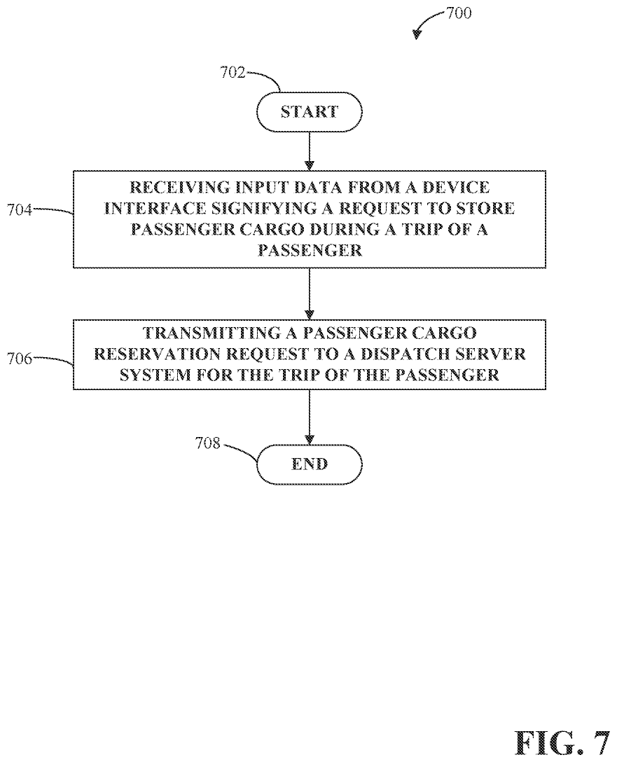

FIG. 5 illustrates an exemplary methodology 500 for selecting an autonomous vehicle for a trip of a passenger in the autonomous vehicle. FIG. 6 illustrates an exemplary methodology 600 for operating an autonomous vehicle for a trip of a passenger. FIG. 7 illustrates an exemplary methodology 700 for employing a mobile computing device to request for a trip of a passenger in an autonomous vehicle. While the methodologies 500, 600, and 700 are shown as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium displayed on a display device, and/or the like.

Referring now to FIG. 5, the methodology 500 begins at 502, and at 504, real time load data from a fleet of autonomous vehicles is received at a dispatch server system. At 506, a passenger cargo reservation request requesting to store passenger cargo for a trip in an autonomous vehicle can be received from a mobile computing device at the dispatch server system. The passenger cargo reservation request can be included as part of a ride request. Alternatively, the passenger cargo reservation request can be separate from the ride request (e.g., separate requests can be sent from the mobile computing device of the user to the dispatch server system). At 508, an autonomous vehicle from the fleet of autonomous vehicles can be identified for the trip of the passenger. The autonomous vehicle from the fleet of autonomous vehicles can be identified based on the passenger cargo reservation request and the real time load data for the autonomous vehicles in the fleet of autonomous vehicles. At 510, a request is transmitted to the identified autonomous vehicle. The request can cause the identified autonomous vehicle to move to a pick-up location for the trip of the passenger.

In an embodiment of the methodology 500, the passenger cargo reservation request can include information specifying an amount of the passenger cargo. The autonomous vehicle from the fleet of autonomous vehicles can be identified based on the amount of the passenger cargo. Moreover, the request transmitted to the identified autonomous vehicle can cause the autonomous vehicle to allocate an amount of the cargo storage area to store the amount of the passenger cargo specified in the passenger cargo reservation request.

In another embodiment of the methodology 500, the request transmitted to the autonomous vehicle can cause the autonomous vehicle to secure a cargo storage area of the identified autonomous vehicle as the identified autonomous moves to the pick-up location for the trip of the passenger. Securing the cargo storage area can prevent a user from accessing the cargo storage area.

In a further embodiment of the methodology 500, the passenger cargo reservation request an indicate a type of the passenger cargo. The autonomous vehicle from the fleet of autonomous vehicles can be further identified based on the type of the passenger cargo.

In yet another embodiment of the methodology 500, identifying the autonomous vehicle from the fleet of autonomous vehicles comprises transmitting vehicle suggestion data to the mobile computing device of the passenger. The vehicle suggestion data can include the real time load data from the fleet of autonomous vehicles. Identifying the autonomous vehicle from the fleet of autonomous vehicles further comprises receiving selection data from the mobile computing device of the passenger. The selection data can indicate selection of an autonomous vehicle from the fleet of autonomous vehicles.

The methodology 600 starts at 602, and at 604 real time load data for a cargo storage area of an autonomous vehicle can be determined. For instance, the real time load data can be determined at least in part based on sensor data provided by a storage sensor of the autonomous vehicle. At 606, the real time load data can be transmitted from the autonomous vehicle to a dispatch server system. At 608, a request for a trip of a passenger in the autonomous vehicle is received from the dispatch server system. The request can be transmitted to the autonomous vehicle based on the real time load data and a passenger cargo reservation request for the passenger. At 610, the autonomous vehicle is maneuvered to a pick-up location for the trip of the passenger by controlling at least one of a vehicle propulsion system, a braking system, or a steering system. The methodology 600 concludes at 612.

Referring now to FIG. 7, the methodology 700 starts at 702, and at 704 input data is received by a device interface signifying input is received by the device interface. The input data can indicate a request to store passenger cargo in a cargo storage area of the autonomous vehicle. The input data can further indicate an amount of passenger cargo. At 706, a passenger cargo reservation request can be transmitted to a dispatch server system. The passenger cargo reservation request can be included as part of a ride request and/or can be transmitted separately from the ride request The passenger cargo reservation request (and/or the ride request) can be configured for use by the dispatch server system to select an autonomous vehicle from a fleet of autonomous vehicles for the trip of the passenger. The methodology 700 concludes at 708.

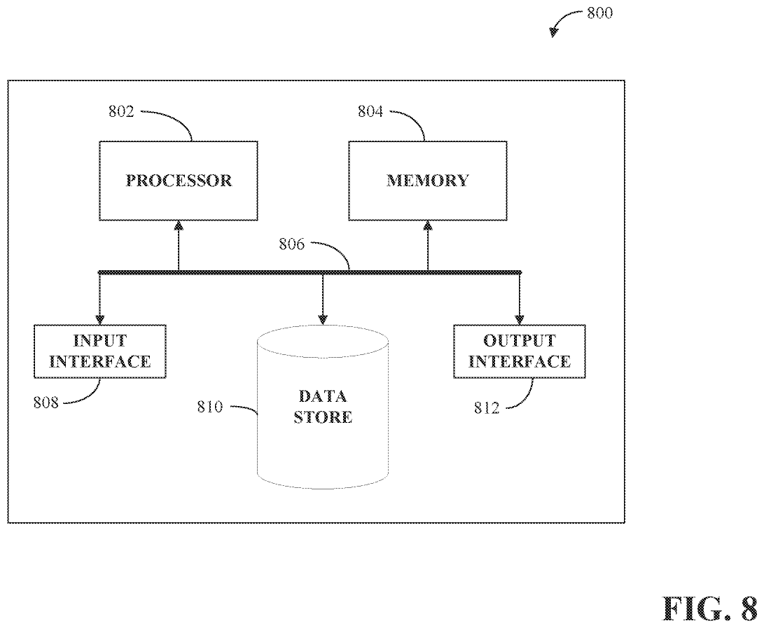

Referring now to FIG. 8, a high-level illustration of an exemplary computing device that can be used in accordance with the systems and methodologies disclosed herein is illustrated. For instance, the computing device 800 may be or include the mobile computing device or the dispatch server system. The computing device 800 includes at least one processor 802 that executes instructions that are stored in a memory 804. The instructions may be, for instance, instructions for implementing functionality described as being carried out by one or more components discussed above or instructions for implementing one or more methods described above. The processor 802 may be a GPU, a plurality of GPUs, a CPU, a plurality of CPUs, a multi-core processor, etc. The processor 802 may access the memory 804 by way of a system bus 806. In addition to storing executable instructions, the memory 804 may also store images, data specifying characteristics of specific objects, etc.

The computing device 800 additionally includes a data store 810 that is accessible by the processor 802 by way of the system bus 806. The data store 810 may include executable instructions, images, data specifying characteristics of specific objects, etc. The computing device 800 also includes an input interface 508 that allows external devices to communicate with the computing device 800. For instance, the input interface 508 may be used to receive instructions from an external computer device, from a user, etc. The computing device 800 also includes an output interface 812 that interfaces the computing device 800 with one or more external devices. For example, the computing device 800 may display text, images, etc. by way of the output interface 812.

Additionally, while illustrated as a single system, it is to be understood that the computing device 800 may be a distributed system. Thus, for instance, several devices may be in communication by way of a network connection and may collectively perform tasks described as being performed by the computing device 800.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. An autonomous vehicle, comprising:
a cargo storage area; and
a computing system comprising:
a processor; and
memory that stores computer-executable instructions that, when executed by the processor, cause the processor to perform acts comprising:
determining, by way of a load detection system, real time load data for the cargo storage area of the autonomous vehicle;
transmitting the real time load data to a dispatch server system;
receiving, from the dispatch server system, a request for a trip of a passenger in the autonomous vehicle, wherein the request is transmitted to the autonomous vehicle based on the real time load data and a passenger cargo reservation request for the passenger; and
responsive to receiving the request from the dispatch server system, controlling at least one of a vehicle propulsion system, a braking system, or a steering system to maneuver the autonomous vehicle to a pick-up location for the trip of the passenger.

2. The autonomous vehicle of claim 1, wherein the load detection system comprises a weight scale configured to determine a weight of passenger cargo currently in the cargo storage area of the autonomous vehicle.

3. The autonomous vehicle of claim 1, wherein the load detection system comprises a camera configured to capture an image of the cargo storage area.

4. The autonomous vehicle of claim 1, the acts further comprising:
securing the cargo storage area as the autonomous vehicle maneuvers to the pick-up location for the trip of the passenger, wherein securing the cargo storage area prevents a differing user from accessing the cargo storage area.

5. The autonomous vehicle of claim 1, wherein:
the passenger cargo reservation request indicates an amount of the cargo storage area desirably reserved for the passenger;
the acts further comprising:
presenting a message to the passenger when passenger cargo of the passenger in the cargo storage area exceeds the amount of the cargo storage area desirably reserved for the passenger.

6. The autonomous vehicle of claim 1, the acts further comprising:
presenting a message to the passenger when the autonomous vehicle reaches a destination for the trip of the passenger in the autonomous vehicle, wherein the message indicates to check the cargo storage area.

7. The autonomous vehicle of claim 6, wherein presenting the message to the passenger comprises transmitting the data from the computing system to a mobile device of the passenger, wherein the data is configured to cause the message to be presented on a display of the mobile device of the passenger.

8. The autonomous vehicle of claim 1, wherein the real time load data further indicates a type of cargo stored in the cargo storage area.

9. The autonomous vehicle of claim 1, wherein the autonomous vehicle is in a fleet of autonomous vehicles

10. A method of selecting an autonomous vehicle for a trip of a passenger in the autonomous vehicle, comprising:
receiving, at a dispatch server system, real time load data from a fleet of autonomous vehicles;
receiving, at the dispatch server system, a passenger cargo reservation request for the trip of the passenger in the autonomous vehicle from a mobile computing device, wherein the passenger cargo reservation request indicates a request to store passenger cargo in a cargo storage area of the autonomous vehicle;
responsive to receiving the passenger cargo reservation request, identifying the autonomous vehicle from the fleet of autonomous vehicles for the trip of the passenger, wherein the autonomous vehicle from the fleet of autonomous vehicles is identified based on the passenger cargo reservation request and the real time load data for the autonomous vehicles in the fleet of autonomous vehicles; and
transmitting a request to the autonomous vehicle, wherein the request causes the autonomous vehicle to move to a pick-up location for the trip of the passenger.

11. The method of claim 10, wherein the passenger cargo reservation request comprises information specifying an amount of the passenger cargo, wherein the autonomous vehicle from the fleet of autonomous vehicles is further identified based on the amount of the passenger cargo.

12. The method of claim 11, wherein the request transmitted to the autonomous vehicle includes an indication of the amount of the passenger cargo, wherein the request transmitted to the autonomous vehicle further causes the autonomous vehicle to allocate an amount of the cargo storage area to store the amount of the passenger cargo.

13. The method of claim 10, wherein the request transmitted to the autonomous vehicle further causes the autonomous vehicle to secure a cargo storage area of the autonomous vehicle as the autonomous vehicle moves to the pick-up location for the trip of the passenger.

14. The method of claim 10, wherein the passenger cargo reservation request indicates a type of the passenger cargo, wherein the autonomous vehicle from the fleet of autonomous vehicles is further identified based on the type of the passenger cargo.

15. The method of claim 10, wherein identifying the autonomous vehicle from the fleet of autonomous vehicles comprises:
transmitting vehicle suggestion data to the mobile computing device of the passenger specifying potential autonomous vehicles for the trip; and
receiving selection data from the mobile computing device of the passenger, wherein the selection data indicates a selection of the autonomous vehicle from the potential autonomous vehicles.

16. A mobile computing device for requesting a trip of a passenger in an autonomous vehicle, comprising:
a device interface configured to receive an input from a user of the mobile computing device;
a processor; and
memory that stores computer-executable instructions that, when executed by the processor, cause the processor to perform acts comprising:
receiving input data from the device interface, wherein the input data indicates a request to store passenger cargo in a cargo storage area of the autonomous vehicle, wherein the input data further indicates an amount of passenger cargo; and
transmitting a passenger cargo reservation request to a dispatch server system, wherein the passenger cargo reservation request includes the request to store passenger cargo in the cargo storage area, wherein the passenger cargo reservation request further indicates the amount of passenger cargo, wherein the passenger cargo reservation request is configured for use by the dispatch server system to select an autonomous vehicle from a fleet of autonomous vehicles for the trip of the passenger.

17. The mobile computing device of claim 16, further comprising a camera, wherein the amount of passenger cargo comprises an image of the passenger cargo captured by the camera.

18. The mobile computing device of claim 16, the acts further comprising:
receiving vehicle suggestion data from the dispatch server system, wherein the vehicle suggestion data includes real time load data from the fleet of autonomous vehicles;
displaying the real time load data on a display of the mobile computing device;
receiving a selection of an autonomous vehicle from the fleet of autonomous vehicles; and
transmitting selection data to the dispatch server system, wherein the selection data indicates the selection of the autonomous vehicle from the fleet of autonomous vehicles.

19. The mobile computing device of claim 16, the acts further comprising:
receiving message data when the autonomous vehicle reaches a destination for the trip of the passenger in the autonomous vehicle, wherein the message data comprises a message to check the cargo storage area; and
presenting the message.

20. The mobile computing device of claim 16, wherein the passenger cargo reservation request is used to allocate a portion of the cargo storage area for storing passenger cargo,
the acts further comprising:
receiving message data when the passenger cargo in the cargo storage area exceeds the allocated portion, wherein the message data comprises a message indicating the passenger cargo exceeds the allocation portion; and
presenting the message.
